(19) United States
(12) Patent Application Publication
(10) Pub. No.: US 2010/0214124 A1
(43) Pub. Date: Aug. 26, 2010

(54) NEW HEAT FLOW MEASURING SYSTEM

(76) Inventors: Alina Lozinski, Jerusalem (IL); Yuli Lozinski, Jerusalem (IL)

Correspondence Address: DANIEL J SWIRSKY, 55 REUVEN ST., BEIT SHEMESH, 99544, IL

(21) Appl. No.: 12/649,394

(22) Filed: Dec. 30, 2009

(30) Foreign Application Priority Data
Feb. 23, 2009 (IL) 197176

(51) Int. Cl. G08C 19/00

(52) U.S. Cl. 340/870.17

(57) ABSTRACT

The invention provides a new system for measuring the heat flow rate between a first and a second medium, the system includes at least two sensor units with signal outputs disposed in a spaced-apart relationship, each of said units including a transducer with apertures allowing fluid to pass through; the transducers are affixed to a first surface on the first medium directly or at least indirectly, and a second surface is exposed to the second medium; thus the said system includes at least two different calibration plates with known coefficient of thermal conductivity and said calibration plates inserted into a measuring line (scheme) of both the sensor units and are affixed behind or in front of the sensor units; the signal outputs of the said transducers arrive to a processing unit for determination and measurement of changes in the heat flow between the said first and the said second sensor units.

### CROSS-REFERENCE TO RELATED APPLICATIONS

This application claims priority benefit from Israel Patent Application No. 197176, filed Feb. 23, 2009, the contents of which are herein incorporated by reference in their entirety.

### FIELD OF THE INVENTION

The present invention relates to a system for the measurement of heat flowing between an object and the ambient air that may be used in medicine, agriculture, building, and other fields.

### BACKGROUND OF THE INVENTION

Heat flow measurements are widely used in medicine, building and agriculture, as described in U.S. Pat. Nos. 4,274,475; 5,524,618; 5,803,915; 6,533,731; 6,595,929 and 7,232,255 B2. Heat flow and temperature differences can be digitally determined and recorded.

U.S. Pat. No. 7,232,255 B2 describes a system for measuring heat flow with at least two sensor units and with the use of a calibration plate, which is placed between first medium and one of the two sensor units. To enlarge the range and possibilities of the measuring system, we propose a new system for measuring heat flow.

### SUMMARY OF THE INVENTION

It is therefore a broad object of the present invention to overcome the disadvantages of the prior systems for measuring heat flow.

In accordance with the present invention, we provide a new system for determining the heat flow rate between the first and the second medium, the said system comprising at least two sensor units, which signal outputs, disposed in a spaced-apart relationship, each of said units includes a transducer with apertures allowing fluid to pass therethrough. The transducers are affixable directly or at least indirectly to a first surface on the first medium while the second surface is exposed to the second medium; thus the said system includes at least two various calibration plates with known coefficients of thermal conductivity. The said calibration plates are inserted into the measuring line (scheme) in both the two sensor units and are affixed to the front or behind the sensor units. The signal outputs of said transducers are sent to a processing unit for determination and measurement of changes in the heat flow between said first and said second sensor units.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates the disposition of the calibration plate in a system for measuring heat flow according to U.S. Pat. No. 7,232,255 B2;

FIG. 2 illustrates a possible disposition of the calibration plate behind the sensor unit in a new system for measuring heat flow.

FIG. 3 and FIG. 4 illustrate other possible dispositions of the calibration plates (behind or in front of the sensor units) in a new system for measuring heat flow.

### DETAILED DESCRIPTION OF THE INVENTION

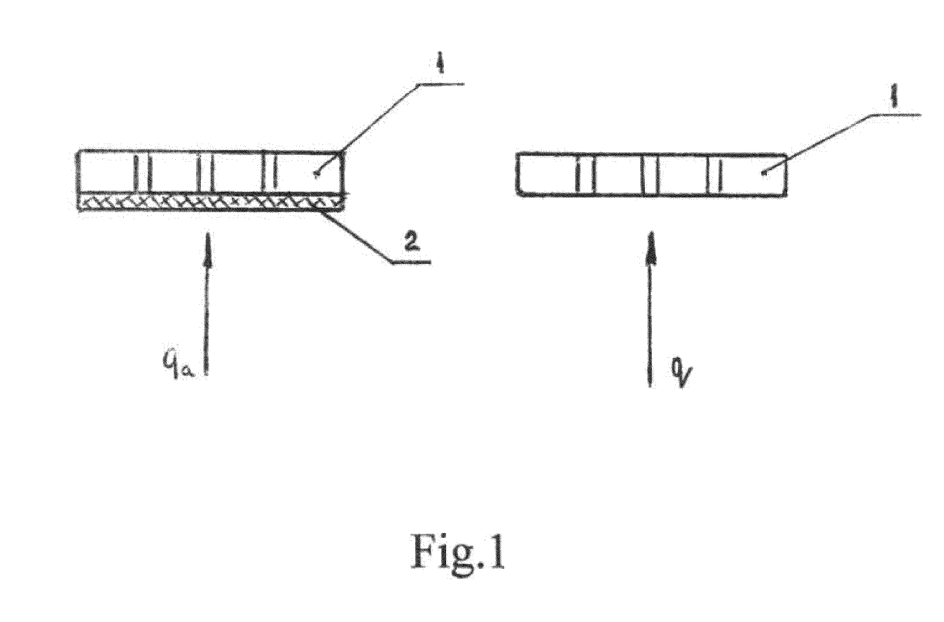

FIG. 1 illustrates the disposition of the calibration plate in a system for measuring heat flow according to U.S. Pat. No. 7,232,255 B2; q-the heat flow through barrier and qₐ—the heat flow through barrier with a plate calibration, which placed in front of the sensor unit: 1-sensor units and 2-calibration plates.

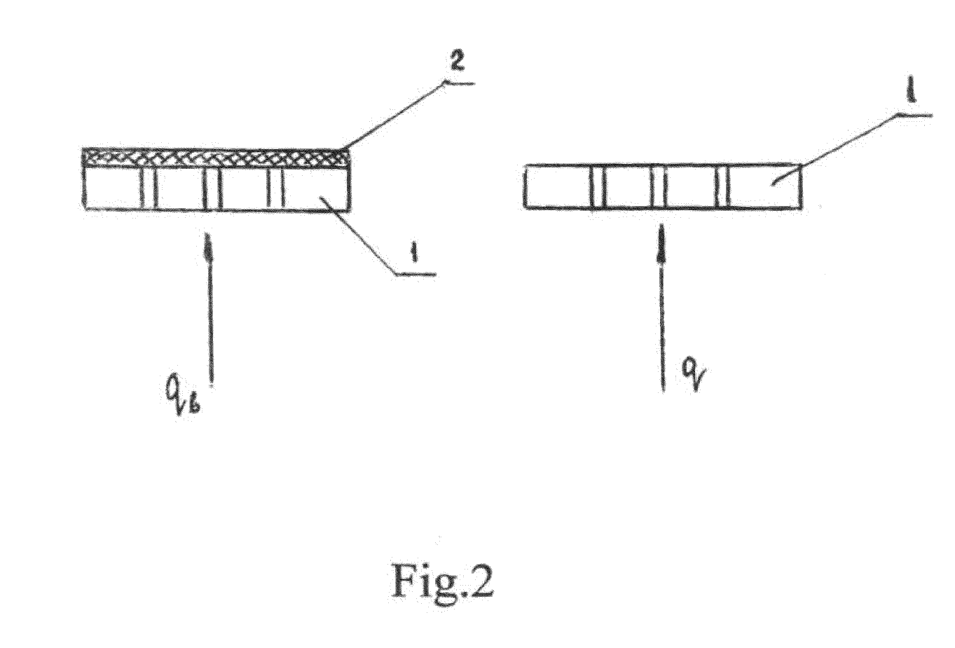

FIG. 2 illustrates a new system for determination and measurement of the heat flow rate; q_{b}-the heat flow through barrier with calibration plate which is placed behind the sensor unit: 1-sensor units and 2-calibration plates.

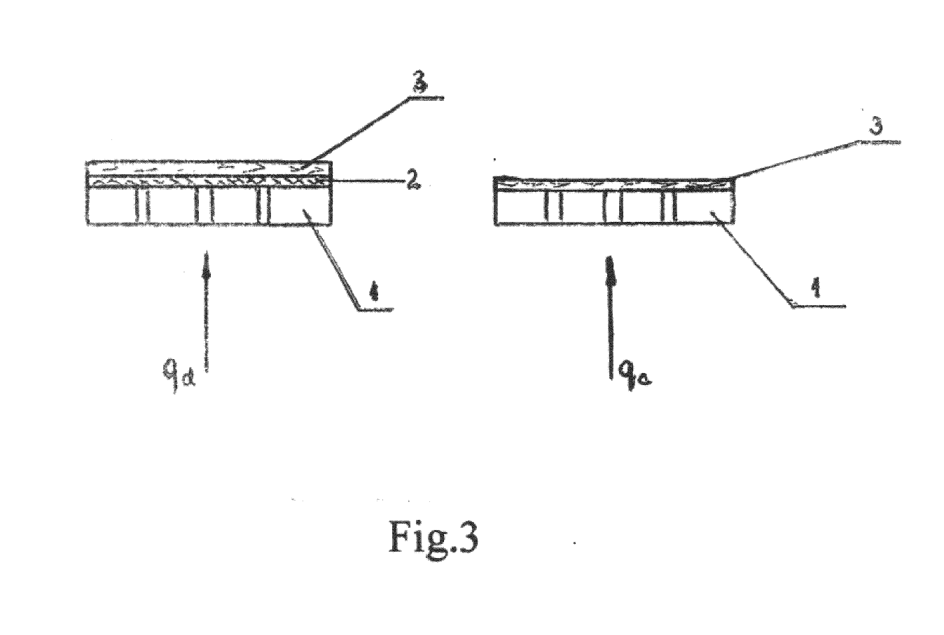

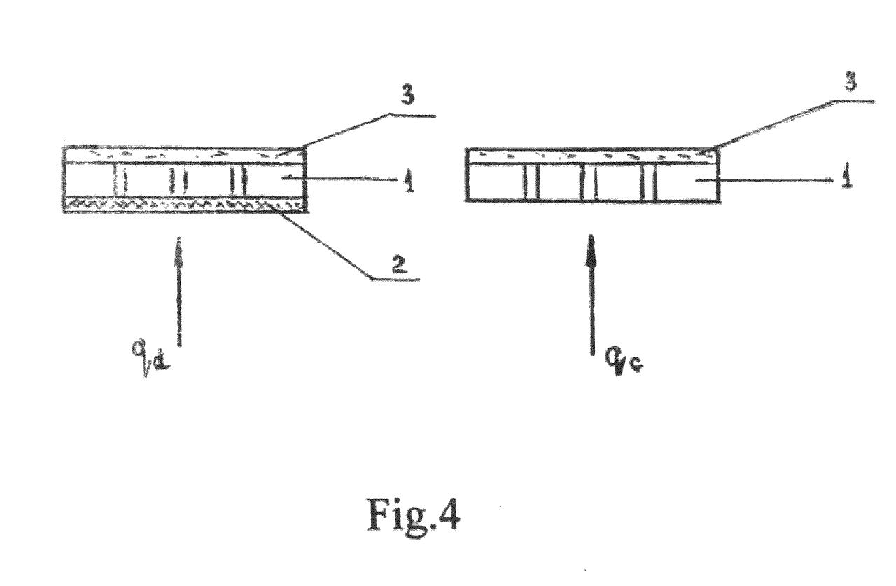

FIG. 3 and FIG. 4 illustrate a new system for determination and measurement of the heat flow rate; q_{c}-the heat flow through barrier with one calibration plate, q_{d}-the heat flow through barrier with two calibration plates: 1-sensor units, 2-calibration plates and 3-other calibration plates.

The present invention is based on the usage of at least two heat flow sensor units with openings for passage of fluid, that are attached with one side to the measured object. The sensor units are attached to the surface of the measured object with calibration plates, which are inserted into the measuring line (scheme) in both the two sensor units and are affixed in front of or behind the sensor units. The calibration plate has predetermined heat and physical characteristics. The calibration plate is made of any material having a known coefficient of thermo-conductivity λ. Preferably, the surface area of the calibration plate should substantially correspond to the surface area of the sensor.

The heat flow q through barrier (FIG. 1) is approximately determined by the formula:

$$q + λ / δ ( {t}_{1} - {t}_{2} ) or ( {t}_{1} - {t}_{2} ) = \frac{q \cdot δ}{λ} , \qquad ( 1 )$$

wherein:
λ=the coefficient of thermal conductivity of the medium to be measured;
δ=the thickness of the medium, and
t₁ and t₂=the input and output temperatures of the medium to be measured.

When the calibration plate (FIG. 1) is added, the temperatures t₁ and t₂ do not change, and the heat flow rate qₐ is determined by the formula:

$$( {t}_{1} - {t}_{2} ) = {q}_{a} ( δ / λ + {δ}_{a} / {λ}_{a} ) or {q}_{a} = \frac{( {t}_{1} - {t}_{2} )}{( δ / λ + {δ}_{a} / {λ}_{a} )} , \qquad ( 2 )$$

wherein:
λₐ=the coefficient of thermal conductivity of the calibration plate;
δₐ=the thickness of the calibration plate;
t₁ and t₂=the input and output temperatures of the medium to be measured, and
λₐ/δₐ=the heat conduction of the calibration plate.

### Thus:

$$λ = \frac{q - {q}_{a}}{{q}_{a}} \cdot \frac{δ}{{δ}_{a}} {λ}_{a} \qquad ( 3 )$$

The values of qd and qc are determined by heat flow sensor units (FIG. 3 and FIG. 4) by the formulae:

(t₁−t₂)=q_{c}(δ/λ+δ_{S}/λ_{S}+δ₁/λ₁) (4),

(t₁−t₂)=q_{d}(δ/λ+δ_{S}/λ_{S}+δ₁/λ₁+δₐ/λₐ) (5),

wherein:
λ_{S}=the coefficient of thermal conductivity of the sensor unit;
λₐ=the coefficient of thermal conductivity of the one calibration plate;
λ₁=the coefficient of thermal conductivity of the other calibration plate;
δ_{S}=the thickness of the sensor unit;
δₐ=the thickness of the one calibration plate;
δ₁=the thickness of the other calibration plate;
t₁ and t₂=the input and output temperatures of the medium to be measured.

### Thus:

(q_{c}−q_{d})(δ/λ+δ_{S}/λ_{S}+δ₁/λ₁)=q_{d}δₐ/λₐ (6),

or

δ/λ=(q_{d}δₐ/λₐ)/(q_{c}−q_{d})−δ_{S}/λ_{S}−δ₁/λ₁ (7).

Thus, according to formulae 7 value λ may be determined, as known coefficients λ_{S}, λₐ, λ₁ and thickness δ, δₐ, δ_{S}, δ₁. The value δ is determined by the medium to be measured, and can be approximated.
Value δ_{S}/λ_{S} for the construction of the sensor units with apertures allowing fluid to pass therethrough tends to equal zero.
Therefore, formulae 7 be simplified

δ/λ=(q_{d}δₐ/λₐ)/(q_{c}−q_{d})−δ₁/λ₁ (8).

Therefore, formulae 8 may be simplified to formulae 3, if we use only one calibration plate for measuring.

What is claimed is:

1. A new system for determining the heat flow rate between a first and a second medium, said system comprising:
at least two sensor units having signal outputs disposed in a spaced-apart relationship, each of said units including a transducer with apertures allowing fluid to pass therethrough;
the transducers are affixed to a first surface on the first medium directly or at least indirectly, and a second surface of the transducers is exposed to the second medium;
the said system includes at least two various calibration plates with known coefficients of thermal conductivity, and the said calibration plates are inserted into the measuring line (scheme) into both the sensor units and are affixed behind or in front of the sensor units;
the signal outputs of the said transducers are sent to a processing unit for determination and measurement of changes in the heat flow between the said first and the said second sensor units.

2. The system as claimed in claim 1, wherein the said first medium is a living body, a structural element, or soil.

3. The system as claimed in claim 1, wherein said second medium is ambient air.

4. The system as claimed in claim 1, further comprising a processing unit connected to a device selected from the group of recording, display or alarm devices.

5. The system as claimed in claim 1, wherein the heat flow rate of each of said sensors enables the calibration of the coefficient of thermal conductivity λ of said first medium, by using the formula
δ/λ=(q_{d}δₐ/λₐ)/(q_{c}−q_{d})−δ_{S}/λ_{S}−δ₁/λ₁,
wherein:
λ_{S}=the coefficient of thermal conductivity of the sensor unit;
λₐ=the coefficient of thermal conductivity of the one calibration plate;
λ₁=the coefficient of thermal conductivity of the other calibration plate;
δ_{S}=the thickness of the sensor unit;
δₐ=the thickness of the one calibration plate;
δ₁=the thickness of the other calibration plate.

6. The system as claimed in claim 1, where using three said sensor units and two said calibration plates and one sensor unit without a calibration plate.
